(19) United States
(12) Patent Application Publication
(10) Pub. No.: US 2003/0163219 A1
(43) Pub. Date: Aug. 28, 2003

(54) Method and system for interactive manufacturing, assembly and testing

(76) Inventor: Robert W. Flesher, Baltimore, MD (US)

Correspondence Address: Carter, Ledyard & Milburn, Suite 300, 1401 Eye Street, N.W., Washington, DC, 20005, US

(21) Appl. No.: 10/325,851

(22) Filed: Dec. 23, 2002

Related U.S. Application Data
(60) Provisional application No. 60/341,848, filed on Dec. 21, 2001.

(51) Int. Cl. G06F 19/00; G09B 19/24

(52) U.S. Cl. 700/185; 702/122; 434/219

(57) ABSTRACT

An apparatus and method for performing standard operating procedures using a computer directed interactive system. The interactive assembly system includes a workstation having a support assembly for a workpiece, and further includes a microprocessor and monitor to convey operator instructions, a plurality of removable attachable tools to assist the user in performing each step of a standard operating procedure. The method comprises: (a) reading instructions provided on the monitor describing each step to be performed for a desired task; (b) observing various indicators located on the workstation to determine the proper tool for a specific step; (c) choosing the desired tool or part for a specific step; (d) performing the required step according to instructions displayed on the monitor; (e) entering data into the microprocessor if necessary; and (f) repeating steps (a)-(e) until the desired task is complete.

### RELATED APPLICATIONS

This application claims priority from U.S. Provisional Application 60/341,848 filed Dec. 21, 2001.

### BACKGROUND

Modem mechanical components and technical devices increasingly must conform to precise tolerances or performance specifications. The modem manufacturer must often manufacture, assemble and test machined components and other devices using sophisticated methods and processes. These methods and processes must be performed by knowledgeable and skilled personnel. In some sectors of the modem economy, it is increasingly difficult to attract, secure or retain personnel with the requisite skills and experience.

Many modern manufacturing, assembly and testing processes, require strict adherence to one or more standardized operating routines, protocols or procedures, which are collectively referred to herein as standard operating routines. In practice, a standard operating routine describes the various steps of a particular manufacturing, assembly or testing process or procedure. In modem lean manufacturing processes, problems may arise when users deviate from the established standard operating routines. The undetected or inadvertent deviation from established standard operating routines may result in a serious reduction in the quality of the resulting component or product.

In the traditional manufacturing environment, extensive training and hands-on experience under close direct supervision by experienced supervisors or instructors is often required. In practice, the need for extensive individualized attention may limit the number of personnel that may be trained or supervised by any one individual. The need for extensive individualized attention can seriously increases cost and reduce the efficiency of operations. The effectiveness of training or performance can also vary dramatically depending on the skill, experience, training or aptitude of the individual instructor or supervisor.

The need to continuously recruit, supervise and train employees for increasing specialized tasks is time consuming and expensive. Traditional methods of training and vocational education have generally utilized a combination of methods involving a combination of classroom instruction followed by a period of closely supervised on-the job training, evaluation and qualification. The recurring need to train and supervise personnel to perform various complex tasks may also present a significant distraction to those supervisors and managers who are also responsible for production and quality control.

In many manufacturing sectors, such as the automotive and aerospace industries, components may be extremely bulky or unwieldy. The need to manipulate or access these components during various phases of manufacturing, assembly or testing may also present a substantial risk of physical injury. For example, the sharp edges of certain components may cause cuts or lacerations. However, in many situations, the use of protective gloves may make it difficult for a user to use, handle or manipulate small or delicate tools or testing devices. The size, bulk or configuration of a component may also make it difficult for a user to physically move or manipulate the component at various stages of the manufacturing assembly or testing process. In other situations, the physical manipulation and handling of components may produce serious injury to the back, shoulders, arms, wrists, hands or feet. This is particularly true in operations that require repetitive movements.

The improper manipulation and handling of a component during manufacturing assembly or testing can also damage the component or the equipment that is used for manufacturing, assembly or testing. Thus, expensive or delicate tools and equipment may be crushed or destroyed by misplaced or mishandled components. The mishandling or misuse of various tools, equipment or components can also compromise the results of sensitive diagnostic tests.

Yet another problem is the need to create, maintain and organize reliable records for manufacturing assembly and testing of components. In many traditional manufacturing, assembly and testing processes, a voluminous amount of paperwork required for ISO, GMP (Good Manufacturing Practices) Mil-Spec certification and other purposes is generated by users at various locations. The resulting documentation is often incomplete, misplaced, mishandled, misfiled or lost.

It is an object of this invention to address these and other problems associated with generally known methods of manufacturing, assembly and testing by providing a novel computer directed interactive system and method for use in manufacturing, assembly, and testing. The computer directed interactive system can be used to control selected manufacturing, assembly and testing processes according to established standard operating routines. The interactive system also permits effective supervision and training of users while they are performing the actual tasks comprising a standard operating routine. In conjunction with an ergonomically designed workstation, the computer directed interactive system can dramatically improve the flexibility and reliability of manufacturing, assembly and testing processes and reduce workplace related injury.

It is an object of this invention to provide a method of training and supervising users which drastically reduces both the cost of training and supervision.

It is another object of the present invention to provide a novel method and system for the computer directed interactive manufacturing, assembly and testing of components in an ergonomically designed work environment.

It is a further object of the present invention to provide a streamlined and standardized work environment for the manufacturing, assembly and testing of components and products.

It is yet another object of the present invention to provide a novel method for ensuring that user correctly perform each step of a standardized multi-step operating in the proper sequence.

It is a yet a further object of the present invention to reduce the risk of user error or oversight by providing a method that effectively eliminates user discretion and variability in the performance of a standard operating routine.

It is yet still a further object of the present invention to provide a flexible and interactive process for manufacturing, assembly and training using a commercially available computer spread sheet program to provide sequencing instructions to the system control program.

It is a further object of the present invention to provide a novel method of electronically recording, maintaining and transmitting manufacturing, assembly and testing records and documentation.

It is yet another object of this invention to provide a computer directed interactive training system.

These and many other objects and advantages of the present invention will be readily apparent to one skilled in the art to which the invention pertains from a perusal of the claims, the appended drawings, and the following detailed description of the preferred embodiments.

### SUMMARY OF THE INVENTION

The present invention is a computer directed interactive system and method. This computer directed interactive system and method, which is referred to herein as the interactive system, allows a manufacturer to establish and monitor the performance of specific manufacturing, assembly and testing tasks according to established standard operating procedures. The interactive system allows a manufacturer to ensure that various manufacturing, assembly and testing procedures are performed in accord with the procedures and sequences that are necessary to ensure the quality and performance of manufactured components. The interactive system also allows a manufacturer to economically and efficiently train personnel to perform a variety of sophisticated multi-step manufacturing, assembly and testing procedures. The interactive system also facilitates the supervision and evaluation of personnel responsible for such procedures. The interactive system also addresses the substantial ergonomic challenges presented in many traditional manufacturing, assembly and testing processes.

The interactive assembly system may include a workstation having a workpiece support assembly, a computer or microprocessor, a system control program, a spreadsheet control program and an associated monitor to convey program instructions from the microprocessor and a plurality of attachable tools or parts to assist the user in performing each step of a standard operating routine. The method comprising: (a) reading the instructions provided on the monitor describing each step to be performed for a desired task; (b) observing various indicators located on the workstation to determine the proper tool or part for the specific step; (c) choosing the desired tool to perform a specific step; (d) performing the required step according to instructions displayed on the monitor; (e) entering data into the microprocessor if necessary; and (f) repeating steps (a)-(e) until the desired task is complete. The system and method also utilizes visual or other types of indicators to guide a user through a standardized operating procedure.

### BRIEF DESCRIPTION OF THE DRAWINGS

FIG. 1 is a perspective view of an interactive workstation according to the present invention.

FIGS. 2a-2d are illustrative views of a component workpiece being held by a workpiece holding fixture and rotated to various positions;

FIG. 3a is a front view of a portion of the vertical surface of an interactive workstation including the monitor, attachable tools, location identifiers and LED indicators

FIG. 3b illustrates how various tool stations may be located on the vertical surface of an interactive work station.

FIG. 4 is a front view of a portion of the vertical surface of an interactive workstation illustrating an arrangement of attachable tools, identifiers and LED indicators on the vertical surface of the interactive workstation;

FIG. 5 is a representative screen shot of a spread sheet program describing a standard operating routine used in the testing of a manufactured component.

FIGS. 6a-b are flow charts demonstrating a method of quality testing using the computer directed interactive system;

FIG. 7 is a representative screen shot illustrating a selected step of a standard operating routine for the quality testing of a component using the interactive system;

FIG. 8 is a representative screen shot from a testing sequence using the interactive system;

FIG. 9 is a front and top view of another embodiment of an interactive workstation according to the present invention;

FIG. 10 is a logic diagram representing one way an interactive system may be remotely connected with various types of communication systems; and

FIGS. 11a-c are representative screen shots of a spreadsheet program for a computer directed interactive system for quality assurance testing of automotive components.

### DESCRIPTION OF THE PREFERRED EMBODIMENT

The computer directed interactive system of the present invention introduces several novel solutions to the problems of manufacture, assembly, testing, training, supervision, quality control and record keeping.

In the modern manufacturing environment, the various steps of manufacturing, assembly and testing are preferably performed according to an established standard operating routine. Under conventional methods and systems, a great deal of individual variability in the performance of such standard operating routines is possible. Modern principles of lean manufacturing dictate the need for a systematic method and approach that provides for consistent performance according to standard operating routines while also providing sufficient flexibility to accommodate changing requirements and specifications.

The automotive and aerospace industries provide examples of the myriad challenges facing modern manufacturers. In the automotive and the aerospace industry, original and replacement components are manufactured to predetermined specifications and tolerances at different locations. Many of these components, such as transmission casings, engine casings and similar components, are large, heavy and geometrically complex. These components are often difficult to handle or manipulate.

During the assembly and manufacturing process, components must be tested for quality and for conformance with specified tolerances and criteria. Historically, such testing is performed by highly trained technicians using a wide variety of tools and methods. The computer directed interactive method and system of the present invention described herein may be used in the quality control and testing of engine and transmission casings and similar components, for example. However, it will be readily apparent to one skilled in the art that the computer directed interactive system is capable of being adapted for use in all types of manufacturing, assembly and testing applications.

In the interactive system described herein, a manufacturing, assembly or testing process is distilled into a standard operating procedure. Each step of the standard operating procedure is then incorporated into an easily modified and updated spreadsheet control program. This spreadsheet control program identifies each step of a standard operating procedure. The spreadsheet control program tells a system program what the standard operating procedure is. The spreadsheet control program is user modifiable. For each step, the workstation monitor shows how each step of the standard operating procedure is to be performed, identifies the specific tool, gauge or device to be used for each step and records the satisfactory completion of the step before the user is allowed to proceed to the next step of the standard operating procedure. The pace of the process may be preset or may automatically adapt to the skill or experience of the user. The specifics of the spreadsheet control program describing the standard operating procedure and the physical layout of the workstation can be readily adapted to accommodate changes or variations in the standard operating procedure or relevant parameters.

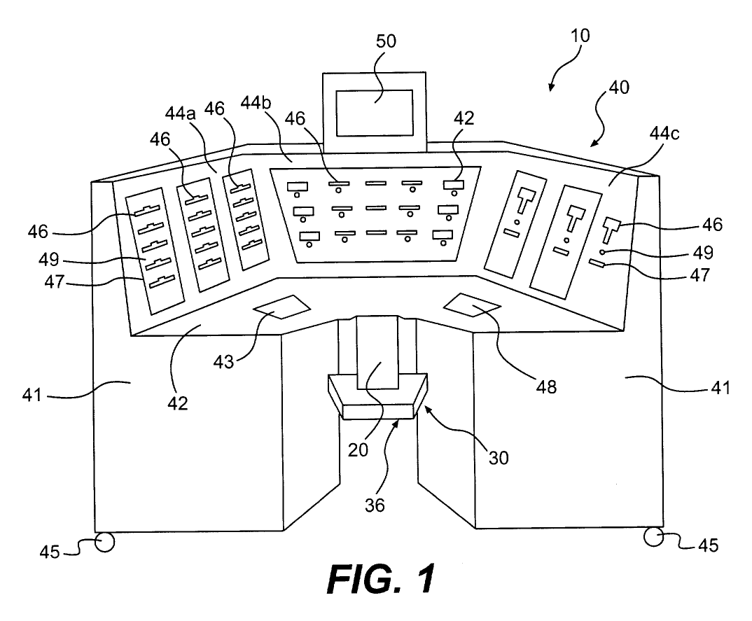

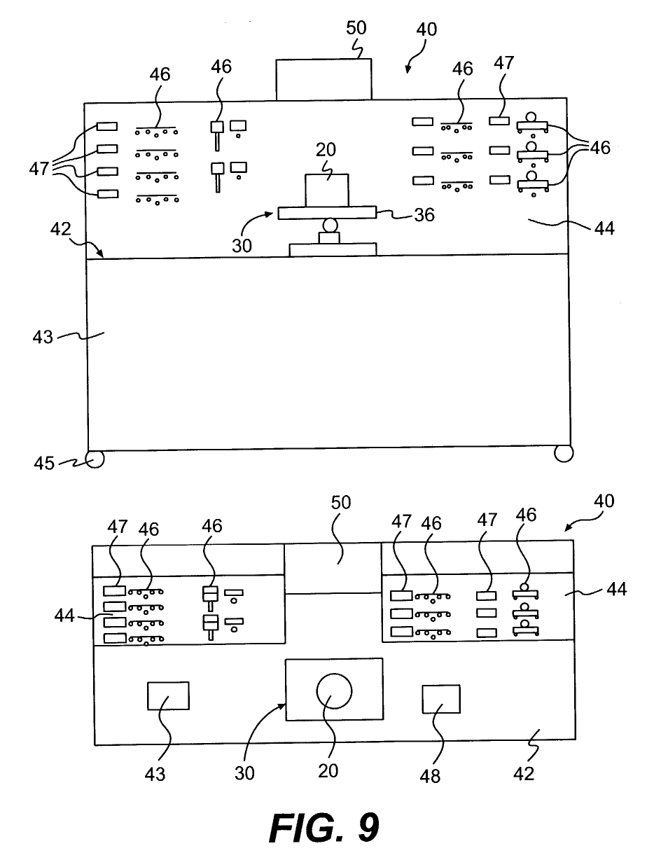

The interactive system 10 includes an interactive workstation 40. FIG. 1 illustrates a perspective view of an interactive workstation 40 adapted for use in the testing and gauging of components, such as an automotive transmission casing. The workstation 40 includes at least one base member 41 that supports a horizontal work surface 42 and one or more substantially vertical surfaces 44 that in this embodiment are located around the outer perimeter of the horizontal work surface 42. The horizontal 42 and vertical surfaces 44 can be of various shapes and configurations that are adapted to the needs of specific processes. The 120 degree curved design of the horizontal work surface 42 illustrated in FIG. 1 maximizes ergonomic efficiency, storage, accessibility and work area. FIG. 9 illustrates an alternative embodiment of the workstation 40.

The workstation 40 is equipped with a personal computer, microprocessor or other type of data processing means (not shown) such as, for example, a personal computer having a 1.0 GHz Intel Pentium microprocessor and a Microsoft Windows Operating System that is capable of receiving, processing and storing inputted data. The workstation 40 may also be equipped with one or more input devices 48 including one or more keyboard, touch pad and/or computer mouse. Depending on the needs of an application, any other conventional form of input device including cameras, scanners, laser optics, foot switches and light curtains may be interfaced with the interactive system and program.

The horizontal work surface 42 of the workstation 40 may accommodate the various input device 48 for the micro processing means (not shown) of the workstation 40. The horizontal work surface 42 may also accommodate additional tool or part storage areas 43. The base member 41 of the workstation 40 may also be used to provide storage for manuals, checklists, telephone, components or other equipment.

The monitor 50 is connected to the personal computer, microprocessor, server or other type of data processing means (not shown). The monitor 50 is capable of displaying drawings, photographs, text and other visual images developed to guide a user through each step of a standard operating routine. The size, location and number of monitor 50 may be adapted to the specific application. The monitor 50 can include a television screen, a computer monitor, projection screen or any combination of display devices known to one skilled in the art.

In FIGS. 1 and 9, the monitor 50 is located on the upper middle portion of the generally vertical surface 44 of the workstation 40. This allows a user to view the monitor 50 while having easy access to the attachable tools 46 located on the vertical surface 44 and to the various input devices 48. This arrangement also allows a user with ready access to the workpiece support assembly 30 and horizontal work surface 42 including the input devices 48 or storage area 43 on such surface 44. The workstation 40 itself may be equipped with the conventional electronic systems, motors, pumps clamps and other equipment (not shown) necessary to perform the tasks of a particular standard operating routine.

As illustrated in the embodiment of FIG. 1, the vertical work surface 44 may contain one or more banks 44a-c. Each of these banks 44a-c may be adapted to hold various types of attachable tools 46. The attachable tools 46 may include the types of tools needed for the desired task for training or performance of the job. The tools 46 include the various gages, tools, fixtures, parts and mechanical devices necessary for the user to perform a desired task in the manufacture, assembly or testing of components according to a standard operating routine. The tools 46 may include gages and devices used in the testing and quality assurance of manufactured components. For example, the tools 46 may include those tools needed to loosen or tighten various size bolts on a component workpiece 20. The tools 46 may also include various types of measuring gages used to determine the amount of torque applied in tightening certain components located on the workpiece 20. As illustrated in FIG. 1, the location of tools 46 on the banks 44a-c of the vertical surface 44 of the workstation 40 promotes visibility, reduces fatigue and minimizes the chance that delicate tools or parts may be misplaced or damaged.

The monitor 50 is connected to and capable of displaying visual and text images from a local or remote computer device (not shown). The monitor 50 provides visual images and instructions for the user to perform the desired task according to a standard operating routine. These images are programmed to guide users through each step of a standard operating routine.

The interactive workstation 40 may be completely self-contained and mounted on locking wheels or casters 48. In one embodiment, the workstation 40 requires only a grounded 110 V receptacle for electrical power. This allows the workstation 40 to be relocated simply and quickly. The use of an on-board Uninterruptible Power Supply (UPS) (not shown) may also allow for safe shutdown in the event of power loss.

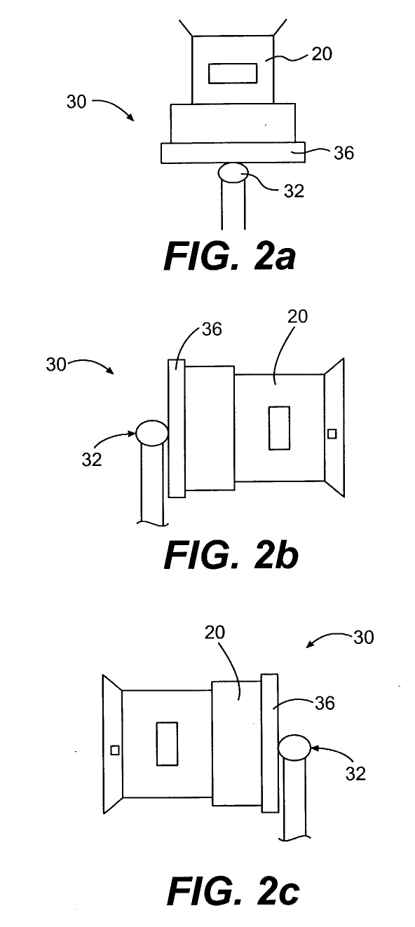

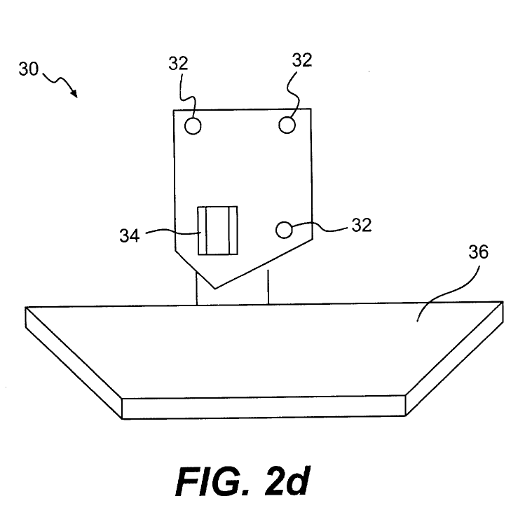

In the embodiment illustrated in FIG. 1, the risk of user strain and injury may be further reduced by the location of a workpiece support assembly 30 adapted to hold and manipulate a component workpiece 20. The support assembly 30, as illustrated in FIGS. 1 and 2a-d, is adapted for use in the testing of an automotive transmission casing or similar mechanical component. In this embodiment, the workpiece 20 is placed on the loading table 36. The workpiece 20 is attached to the workpiece support assembly 30 by four guide pins 32 and held in place by a spring loaded trap clamp 34. In the embodiment illustrated in FIG. 1, the workplace 20 may be lowered by an electric linear activator or similar motive means (not shown) to provide clearance.

FIGS. 2a-2c further illustrates how the component workpiece 20 can be maneuvered to and held in various orientations so that a user may have access to each side of the component workpiece 20. As illustrated in FIGS. 2a-2c, the support assembly 30 may include a loading table 36 and pivotal member 32 which allows the loading table 36 of the support assembly 30 and the component workpiece 20 to rotate and pivot around its axis and then be placed in a locked position.

The workpiece 20 may be attached to the support assembly 30 by clamps, pins or other know attachment means adapted to the particular component. For example, in FIG. 2d, the workpiece 20 is located on and secured to the loading table 36 portion of the support assembly 30 by a combination of tapered steel pins 32 and a spring loaded clamp 34 that are adapted to hold the workpiece 20 securely in place in all rotational attitudes. As illustrated in FIG. 9, depending on the application, a support assembly 30 comprising a loading table 36 may also be mounted on the horizontal surface 42 of the workstation 40. The support assembly 30 may be customized to accommodate a variety of manufacturing, assembly and testing standard operating routines.

The individual tools 46 used to perform a standard operating procedure may include the various types of testing gages, gauges, devices, tools, parts or equipment used in a particular manufacturing, assembly and testing routine. These tools 46 are located on a generally vertical surface 44 within a user's field of vision and within easy reach. The location of the tools 46 on the vertical surface 44 of the workstation 40 promotes visibility, reduces user fatigue and reduces the potential for damage to instruments and equipment used in the assembly, manufacturing or testing operations. The attachable tools 46 may be grouped into categories, so as to make it easier for the user to locate a specific tool 46 on the vertical surface 44 of the workstation 40.

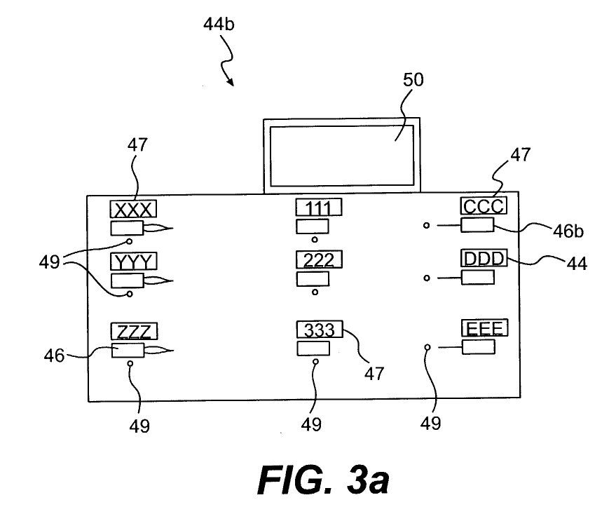

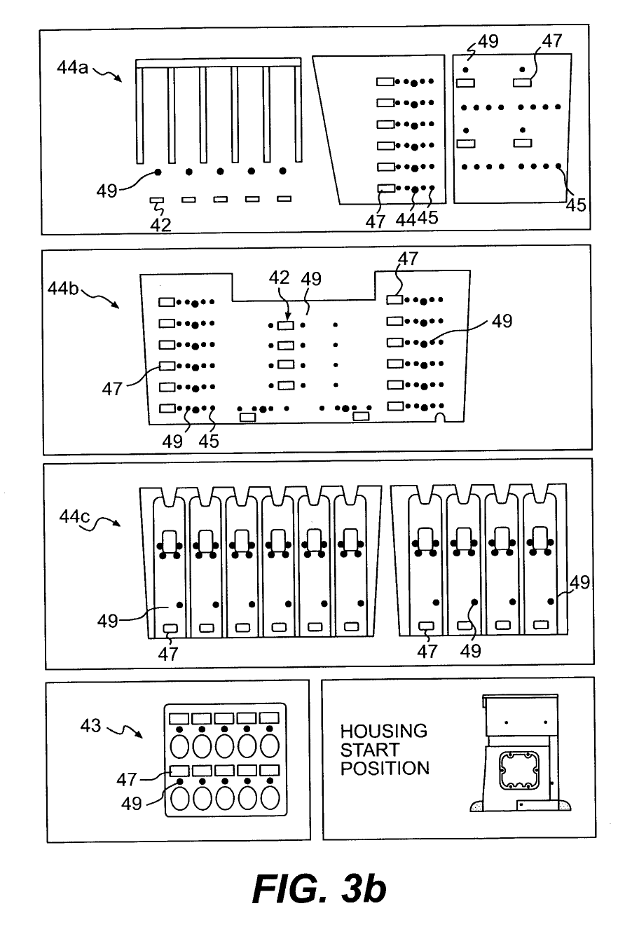

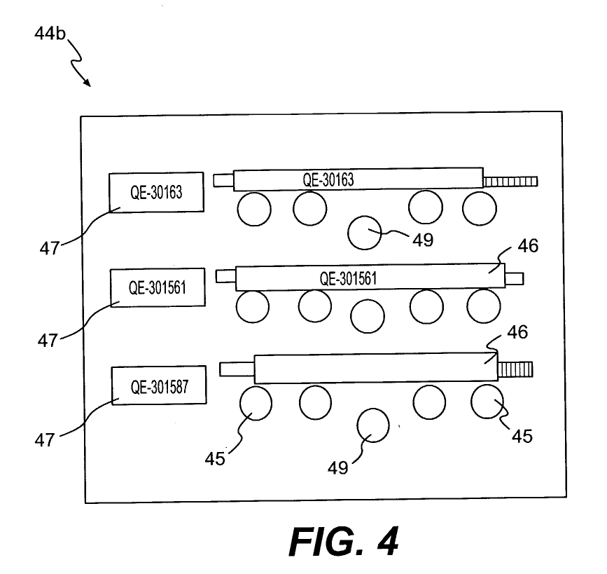

As illustrated in FIG. 3a, the specific storage location or tool stations for individual tools 46 on the vertical surface 44 of the workstation 40 may be labeled with an identifiers 47 for each of the removable and attachable tools 46. The identifiers 47 identifies the proper location of each tool 46. Depending on the application, the tool identifier 47 may utilize an alphabetical code, numeric code, color code, bar code or some combination thereof. As illustrated in FIG. 4, the identifying code on the identifier 47 may be also located on the tool 46, itself. One or more visual indicators 49, such as LED indicators, may also be associated with an identifier 47. The indicator 49 is operatively connected to the microprocessor (not shown) and used to identify the location of a tool 46 on the vertical surface 44. The tool 46 and associated tool identifiers 47 may be permanently affixed to the vertical surface 44 of the workstation 40 or may be removable or may be attached to, or visible through a parts bin that is removable.

The vertical surface 44 of the workstation 40 may be easily reconfigured to accommodate various components or standard operating routines. For example, tool holders 49 of varying configurations may be built into the vertical surface 44 of the workstation 40 to allow for future additions. As illustrated in FIGS. 3a and 3b, the individual various banks 44a-c of the vertical surface 44 of the workstation 40 may be selectively arranged to accommodate the different types of tools 46 used to perform a standard operating routine. As shown in FIGS. 3a and 3b, the location of each tool 46, or tool station, on the vertical surface 44 may be assigned a sequential station number or other form of station identification. A sequential station number or identifier may be used to identify each tool station and the associated tool 46.

Each of the vertical surfaces 44 of the workstation 40 for example as illustrated in FIG. 4, bank 44b may be arranged to accommodate various types of tools 46 using support pins or other types of holders 45. Depending on the user's requirement and costs, the holders 45 may accommodate various types of tools 46, parts, equipment and devices. The various types of holders 45 may include: (1) slots to accept hole location template gauges, (2) internal bosses to accept barrel-type flush pin gauges; (3) pins adapted to accept a wide range of plug type gauges, including male thread gauges and depth gauges, and (4) support pins configured to accept bore gauges combined with adjustable locking collars to accept the corresponding master ring. Other types of fixtures and holders 45 may be used to accommodate the tools and devices required for the specific operating routine.

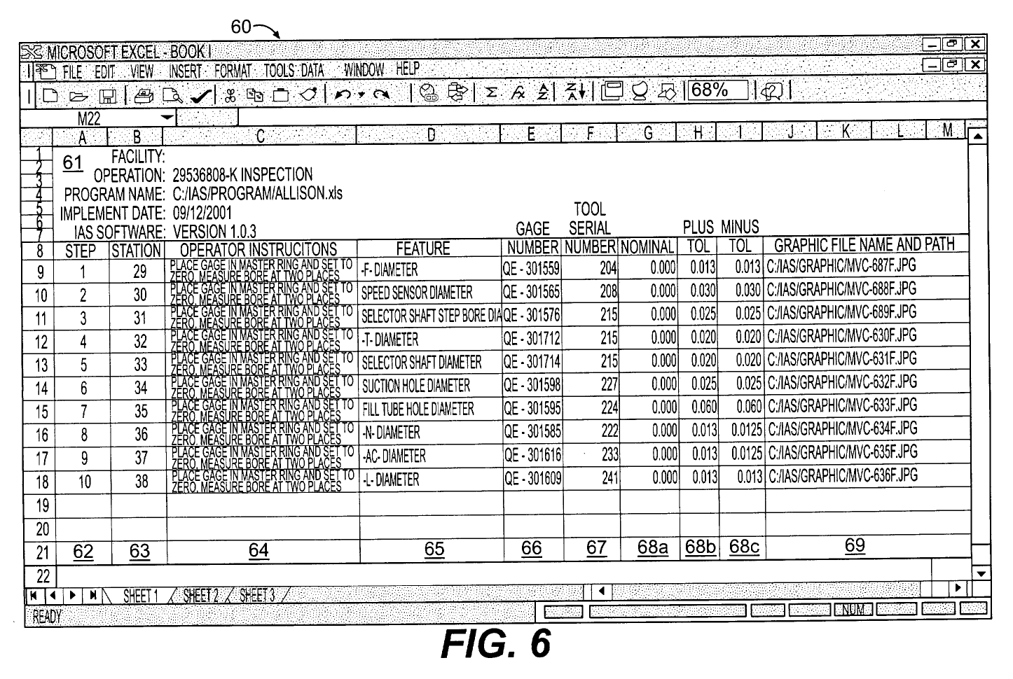

The interactive system 10 is controlled by a system control program that cannot be modified by the interactive system user. The spreadsheet control program, using a conventional spreadsheet program, is user modifiable. The spreadsheet control program is used to tell the system program what the standard operating procedure is. FIG. 6 illustrates a typical spreadsheet control program 60 used to control the sequence of testing operations at the workstation. In this embodiment, each step of a standard operating procedure for a particular operation is identified at screen shot portion 62. In this program 60, the specific stations and workpiece features are identified at screen shot portions 63 and 65 respectively. Specific operating instructions for each step of the standard operating procedure are provided at screen shot portions 64. The spreadsheet program 60 also identifies the gauge number and tool serial number for each step as show at screen shot portion 66 and 67 respectively. In this program 60, the LED indicators may be mapped in the column at screen shot portion 63. The picture file paths of each step are specified in another column at screen shot portion 69. The spreadsheet header at screen shot portion 61 can also be adapted to identify the facility, operation, testing software, date, user and other relevant information. The program 60 may be created for use at an individual workstation 40 or may be tailored for various types of assembly processes or standard operating procedures.

The use of a spreadsheet program format provides a familiar interface for the user, supervisors and system administrator. Moreover, adding, changing or removing steps in the process requires nothing more than editing the spreadsheet control program. For example, specifying the picture to be displayed for each step may be done by mapping the picture's location and file name within the spreadsheet. Similarly, specifying which LED indicator to illuminate for each step is done by inputting the station number that corresponds to the correct gauge for that step.

Through the use of an integrated personal computer or similar processing device, the interactive system 10 is capable of leading a user through a specific sequence of steps comprising a standard operating procedure. The monitor 50 of the workstation 40 is capable of displaying a visual image of each step in a standard operating procedure. The system microprocessor performs the required calculations and handles the indicator switching, safety logic and data formatting functions based upon the system control program. The system control program is customized to accommodate a specific standard operating procedure. The order of steps and information displayed is defined by the spreadsheet control program. The system control program is not user accessible but takes its instructions from the spreadsheet control program which is user accessible.

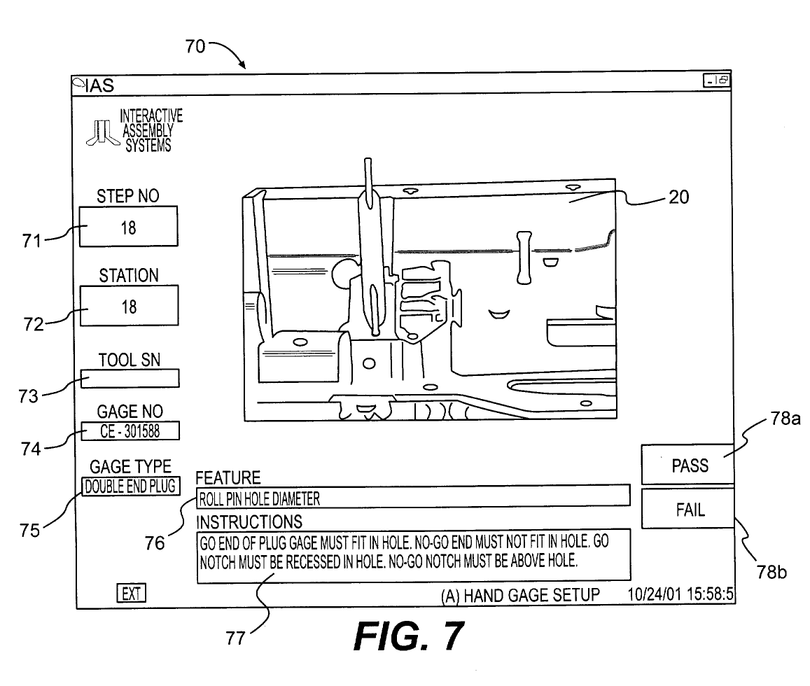

For example, FIG. 7 illustrates a representative screen shot 70 displaying a selected step of a standard operating procedure. As shown at screen shot portion 71 the screen identifies the step. The screen shot also identifies the station 72, tool serial number 73, gage number 74 and gage type 75. The screen shot 70 illustrates the use of a tool 46 relative to a selected feature of the workpiece component 20. The screen shot 70 identifies the features being tested at screen shot portion 76 and provides the user with written instructions at screen shot portion 77. As illustrated in screen shot portion 78a and 78b of FIG. 7, the program 60 may also allow the user to indicate the result of a test by indicating “pass” or “fail” on the monitor 50 using an input device 48 such as a mouse, or keyboard entry, or touch screen entry. In this embodiment, the user may not proceed to the next step until a result has been correctly recorded.

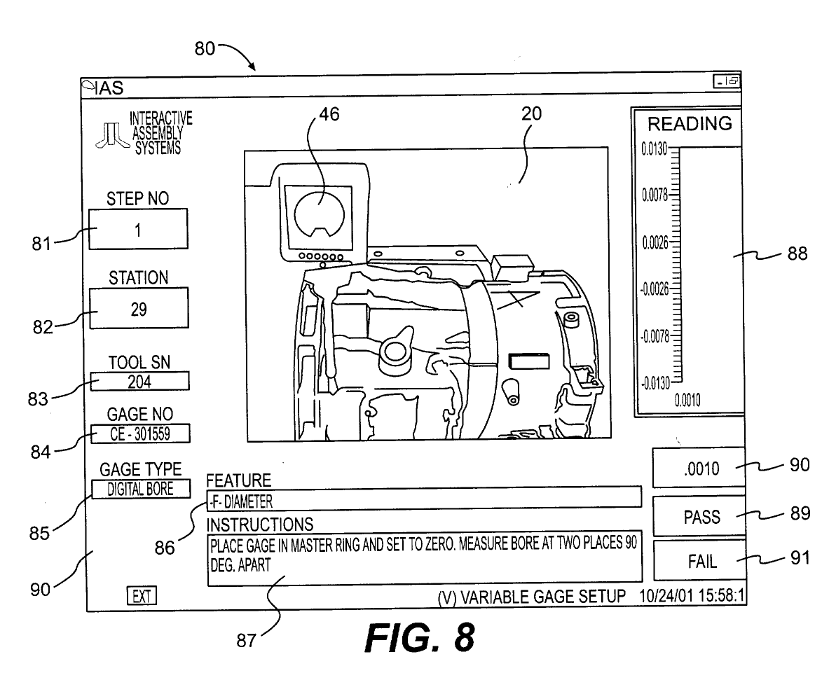

FIG. 8 illustrates another screen shot 80. As further illustrated in screen shot portion 89 of FIG. 8, the spreadsheet control program 60 can accommodate a situation where after the user or instrument is read electronically by the control program, has inputted the value of a measurement, the software makes a pass/fail determination based on a predetermined tolerance limit. The step number, tool serial number, age number, gage type and instructions are displayed at screen shot portions 81-87. In this step, a user may be directed to enter the value obtained from the measurement. As shown at screen shot portion 89, the software then makes the pass/fail determination based on a predetermined tolerance limits. As shown at screen shot portion 88 of FIG. 8, the applicable tolerance ranges may also be graphically represented. Depending on the application, the tools 46 and the testing devices attached to the workstation 40 may also be adapted to input results directly to the program. The user moves to the next step of the process by selecting <NEXT> 91.

The software may also be configured to safeguard against keypunch errors. For example, when set at 200% of the feature tolerance, the software will initially reject any entry beyond this range and force the user to re-enter the measurement. However, if the same number is re-entered, the software accepts the redundant input as correct rather than as a keypunch error.

The interactive system may also direct a user to select a particular tool 46 from a range of available choices. One or more LED indicators 49 located on the banks 44a-c of the vertical surface 44 of the workstation 40 may be located at each tool location. As the program steps through each step of the standard operating routine, the LED indicator 49 may be used to identify the proper tool or device 46. By selectively illuminating an LED indicator 49, the specific tool or device 46 used for each step in a process may be visually identified. As the software proceeds through each step of the of standard operating routine, an LED indicator 49 illuminates the next correct tool 46. The user thus simply reaches for the illuminated tool 46 rather than searching through the tools 46 to find the one with the correct identifier 47 The illuminated LED indicator 49 ensures that the user selects the proper tool 46.

As illustrated in the screen shot of FIGS. 7 and 8, as a cross check, the tool's specific identifier 47 may be prominently displayed on the monitor 50. The appropriate identifier 47 can then be matched to the correct location label on the workstation 40 and the correct tool 46. At each step of the program, the user is presented with a visual display identifying the tool 46 to be used, as well as concise written instructions for its use. It is a benefit of the system that the instructions can also be presented in any language, switched between users by a screen input or keyed in identification number. In these situations, for performing a particular step where an attribute (go/no-go) gauge is used, information is provided for making a pass/fail determination.

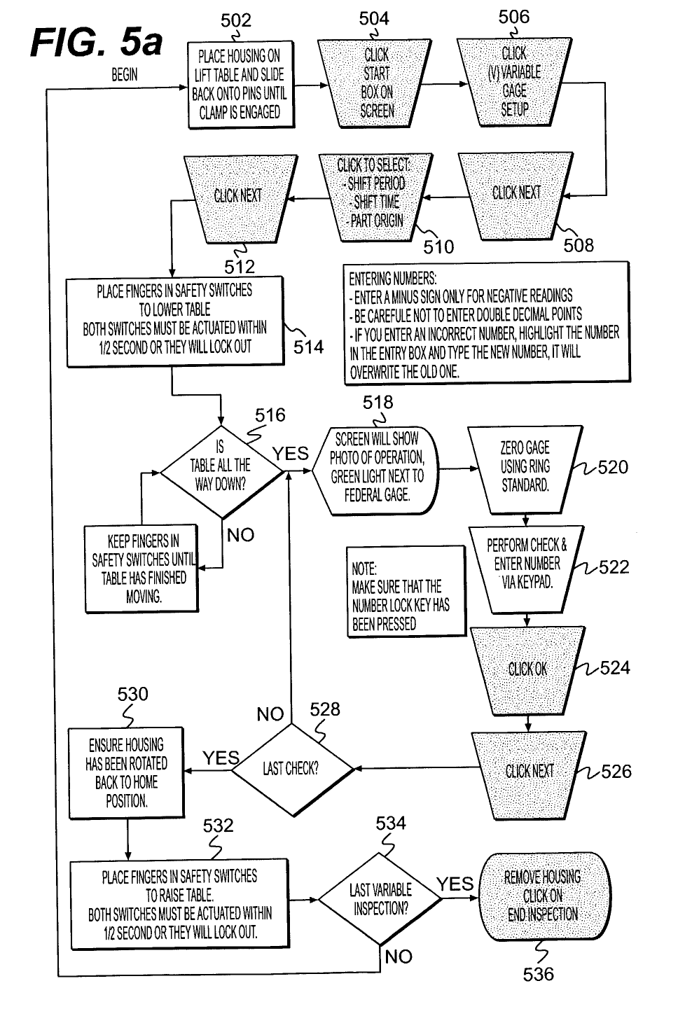

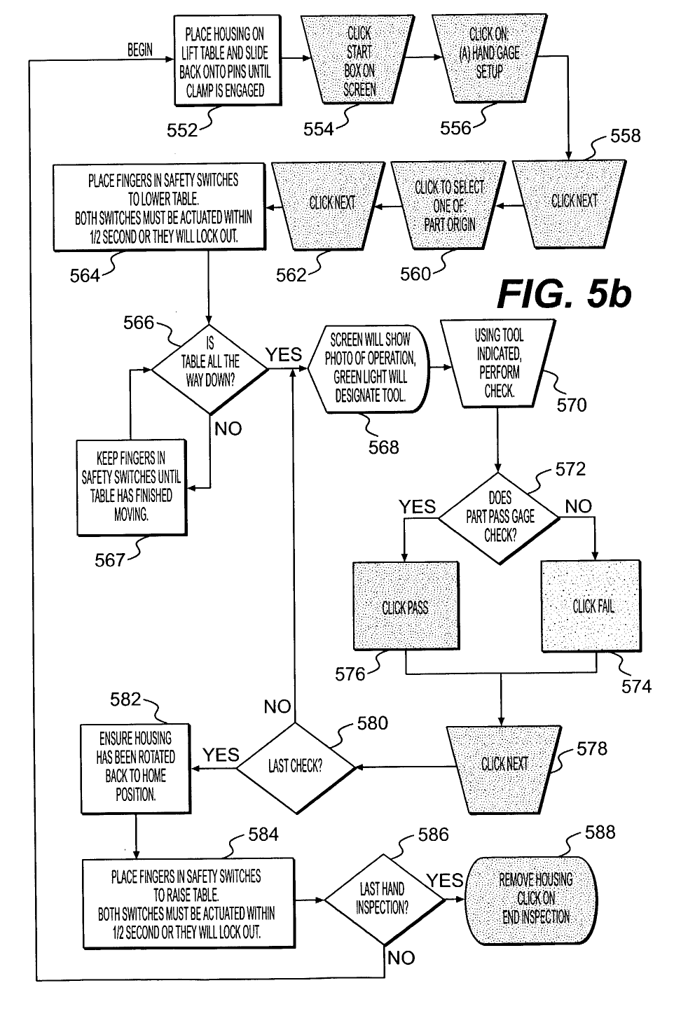

FIGS. 5a-b are flow charts illustrating how an interactive system using a system control and spread sheet control program may be used by an operator for the interactive testing of components. FIG. 5a is a flow chart for performing variable gage testing of an automotive component using the interactive system. The first step of the process 502 involves placing the transmission casing or other type of workpiece to be tested on the support assembly 30. In the embodiment illustrated in FIG. 1, the component 20 is slid onto the pins 32 of the support assembly 30 until the spring clamp 34 is engaged. The user may then click on the start box that is displayed on the screen of the monitor 50. The user then selects 504 and the variable gage setup 506. The user then proceeds to the next screen by clicking <Next> 512. According to step 514, in order to perform the next task, the user lowers the support assembly 30. Once the support assembly 30 is lowered 516, the monitor 50 displays an image of the operation 518 and an indicator 48 located on the vertical surface 44 of the workstation 40 will go on to identify the appropriate tool 46 to be used.

As illustrated in FIG. 5a, the user zeros the gage using a ring standard 520, performs the check and enters the results using a keypad 522. In the next step, the user then acknowledges this entry by clicking <OK> 524 and is allowed to proceed to the next step 526. The remaining steps of the process 518-526, may then be completed until the standard operating procedure described by spreadsheet control program is completed 528. According to the flow chart, if the step is the final step 528 in the process, the component 20 is moved back to the original start position 630-632. The process may then be continued 534 or completed by selecting <End Inspection> 536. The overall process is controlled by the system control program based on inputs received from the spread sheet control program.

The flow chart of FIG. 6b describes a hand gage inspection process using the interactive system. According to the flow chart, the initial steps of the process 552-556 are similar to those described for the process of FIG. 5a. Once the appropriate program has been initiated, the workpiece 20 will be oriented on the support assembly 30 of the work station 40. The screen of the monitor 50 will show a graphic representation or photograph of the operation 568. A representative screen shot is illustrated in FIG. 8. At the same time, an indicator 47 will light and identify the tool to be used for the specific step of the standard operating routine 568. The user may then select the tool 46 from the appropriate location on the workstation 40 and perform the task according to the displayed instructions 570. In this embodiment, the user may select whether the part passes or fails the inspection by selecting <Pass> 576 or <Fail> 574 from the screen shot display. The user then proceeds to the next step by selecting <Next> from the screen display 578. The user then proceeds according to the steps described in FIG. 5b.

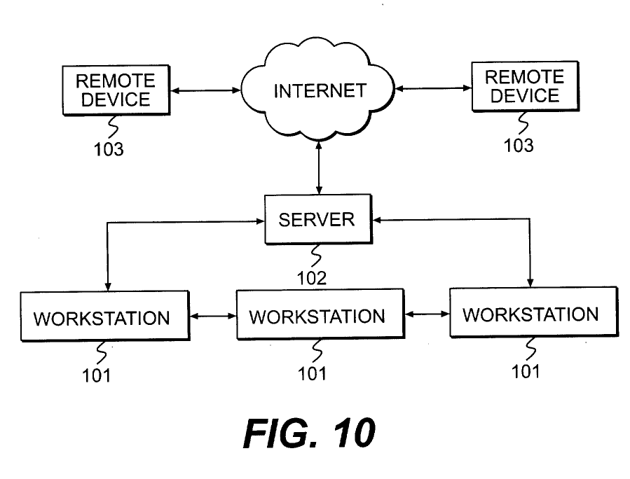

As shown in FIG. 10, the spreadsheet control program may be loaded at the input/output device of each individual workstation 101 or accessed from a central location using a Local Area Network (“LAN”), Wide Area Network (“WAN”) or the Internet. The system control and spreadsheet control programs may be accessed using any suitable conventional input/output device. The data and information may also be transported from the workstation device 101 to other devices 103 or remote servers 102 either by the recording of data using a suitable conventional recording medium or by such other forms of data communications as a LAN, WAN, Ethernet or the Internet. Once the testing program has been accomplished, a record of the testing process may be stored locally. The data may also be reduced to hard copy, or stored and transmitted in electronic or digital form. The electronic information from various individual testing stations at different locations may be electronically transmitted and stored. It is to be understood that the storage and transmission of data can be selectively accomplished using the various known means of electric data transmission and storage.

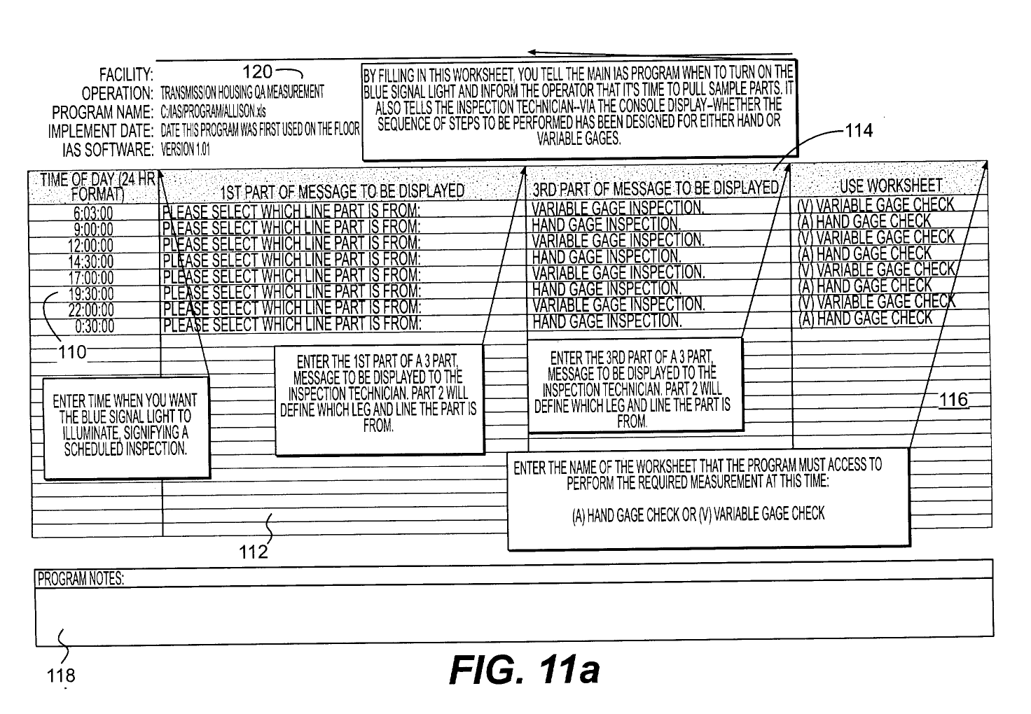

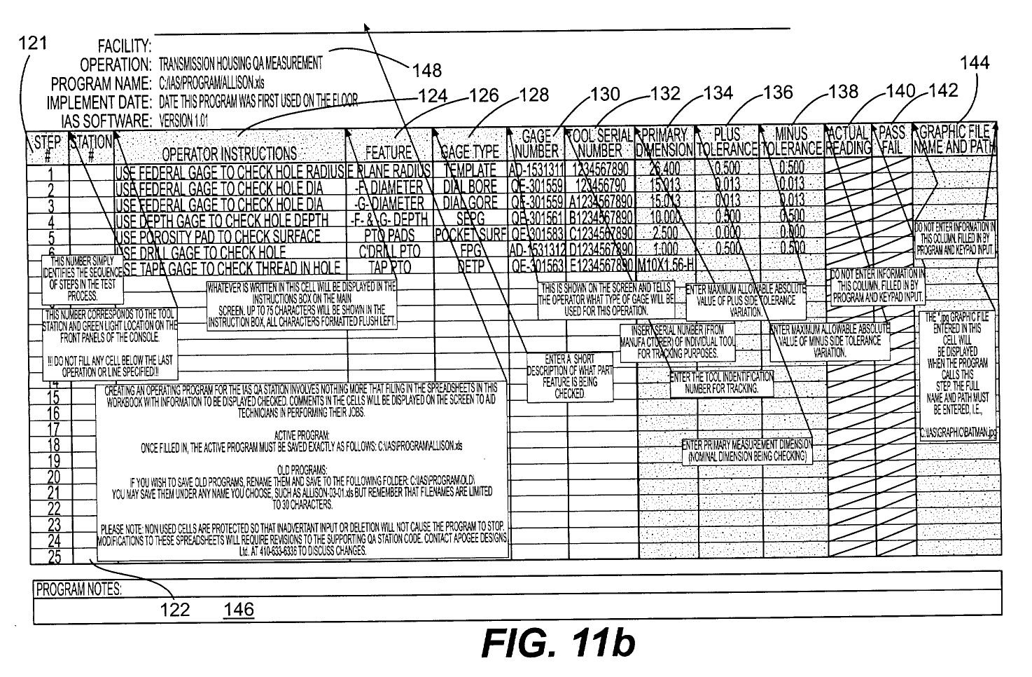

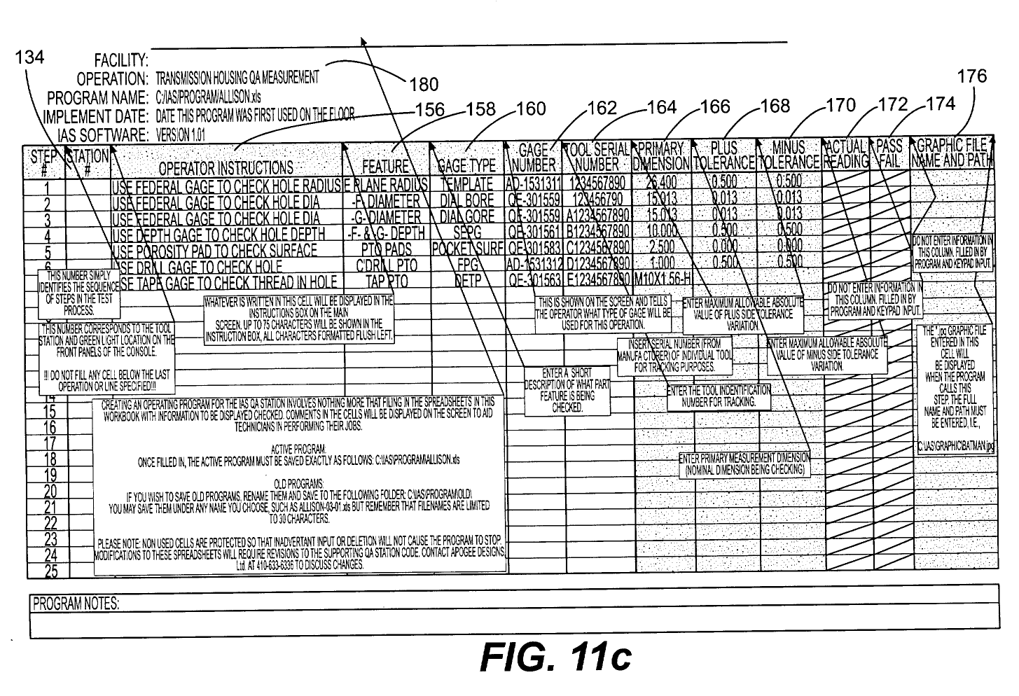

Creating a spreadsheet control program for the interactive system involves completing a spreadsheet program such as Microsoft Excel or similar commercially available program. FIGS. 11a-c are illustrative spreadsheet control programs for standard operating procedures used in the quality assurance testing of automobile transmission casings. As illustrated in FIG. 11a, the first page of the spreadsheet control program is used to identify when it is time for an operator to sample component parts from the assembly line. The first column 110 identifies one or more times when a scheduled inspection is to be performed. The second column 112 is used to identify the part of the assembly line the part is from. The third column 114 identifies the type of inspection to be performed. The fourth column 116 identifies the specific worksheet that the spreadsheet control program must access to perform the required measurements. There is also a location for program notes 118. In this example, either a hand gage check or variable gage check may be selected. The variable gage testing program may be performed according to the system program and spreadsheet control program process of the flow chart in FIG. 5a. The hand gage testing program may be performed according to the flowchart as described in FIG. 5b.

FIG. 11b is a representative spreadsheet control program 120 for the hand gage inspection of a transmission casing using the interactive system. The first column of the program at screen portion 121 identifies the sequence of steps in the process. The second column at screen shot portion 122 identifies a particular tool station number and corresponding indicator 47. The third column at screen shot portion 124 instructs the operator to use a particular tool 46 to test a particular feature of the workpiece 20. The feature to be tested is identified in the column located at screen shot portion 126. The type of tool 46 is listed under the Gage Type column at screen shot portion 128. The tool identifier is provided in the gage number column at screen shot portion 130 The tool serial number may be recorded in the tool serial number column located at screen portion 132. The column for primary dimension at screen shot portion 134 is used to identify the dimension that is being checked. The maximum allowable plus and minus tolerances for each measurement may be included as illustrated at screen shot portions 136 and 138 respectively.

In this example, the actual measurement or pass/fail results may be entered into the appropriate column by the user at screen shot portions 140 and 142 respectively. The final column of the program control spreadsheet at screen shot portion 144 is used to map the graphic instructions and images to be displayed at each step in the process by identifying the name and path of the file. In this embodiment, the graphic picture file, typically a file in jpg or gif format, entered in the column will be displayed when the program calls up that step of the program. The various dialogue boxes or cells shown in the FIGS. 11a-c may be incorporated into the program control spreadsheet and may be displayed to assist users, moreover, as will be apparent to one skilled in the art, not all columns need be utilized for very application.

FIG. 11c illustrates a screen shot for a spreadsheet control program 150. The spreadsheet control program 150 shown in FIG. 11c may be used for a variable gage inspection procedure according to the flow chart of FIG. 5b using the interactive system. Once completed, the spread sheet control program may be saved in an appropriate file for future use. The first column 152 identifies each step of the standard operating procedure. The second column 154 identifies a specific tool location. The third column at screen shot portion 156 provides the user with instructions on how to use a particular tool to perform the desired operational step. In this embodiment, the feature of the workpiece 20 to be tested is identified at screen shot portion 158. The tool 46 type (e.g. template, gage, bore, etc.) is identified at screen shot portion 160. The gage number and tool serial number are shown at screen shot portion 162 and 164 respectively. The column at screen shot portion 166 identifies the primary dimension of the feature. The applicable plus and minus tolerances are shown at screen shot portions 168 and 170 respectively. The actual reading may be inputted by the user in the column at screen shot portion 172. A pass /fail column as shown at screen shot portion 172 may also be entered by the user. The visual images to be used are mapped in the last column at screen shot portion 176.

Through the use of an integrated personal computer or similar device, the system program and spreadsheet control program guide the user through a sequence of steps from the beginning to the end of the inspection. The interactive system eliminates the risk of a skipped step by preventing the user from scrolling forward or backward through the standard operating procedure. The user cannot proceed to the next step until a pass/fail determination has been made on the current step.

The testing results from each testing station may be compiled and the results of the testing forwarded to a central location by conventional means. The compilation and transmission of testing data may occur either automatically or upon specific command. The compilation and transmission of testing data can be scheduled to occur at a predetermined frequency or any other preselected triggering criteria. The compilation and transmission of data can also happen at random intervals.

The interactive testing system stores all records electronically. This eliminates the need for maintaining, transporting and storing paper records. For example, in a testing sequence such as described in the spreadsheet control program shown in FIG. 5 each measurement may be logged into a database. This record allows traceability to the workstation that produced the workpiece and the recorded status of each tested feature. Variable inspection data may be written to an ASCII text file for import into one of many commercially available Statistical Process Control (SPC) programs. The text file contains the measured value for each feature as well as the work shift, machining leg, and time of production. The system administrator has the ability to turn off the data collection feature. This allows inexperienced users an opportunity to practice their techniques without corrupting production data and process control statistics.

The present invention is of great potential benefit to all types of industrial and manufacturing, assembly and testing processes. The invention also provides a system and method for performing each step of a multi-step testing, assembly or manufacturing process according the a predetermined sequence of steps. The method and system may be used to improve quality and reliability of existing procedures. The method and system may also dramatically improve the ability of a manufacturer to train and supervise the personnel who are responsible for various aspects of the manufacturing, assembly and testing process. The invention reduces the cost of training and supervision and also permits more flexible assignment of existing personnel.

Another important advantage of the present invention is the ability to direct and control the user's performance of each step in a standardized multi-step process or routine. According to the method, each user is provided with a workstation monitor that provides a visual image and accompanying written instructions for each step of the standard operating routine. The program may require that the user perform each step in accord with the predetermined sequence before he or she is being allowed to proceed to the next step. The user's ability to follow each step of a predetermined and graphically described process improves overall efficiency and reliability. The use of a standard operating procedure also eliminates user discretion and variation in interpretation and reduces the risk of error or omission. The electronic records of the process also provides additional assurance of quality.

The system and method uses a commercially available spread sheet program such as Microsoft's Excel. This provides a familiar visual interface for each user. Moreover, changes to the standard operating procedure may be readily accomplished by simple editing of the spreadsheet control program using well known methods. In this manner, the individual user may also readily adapt the method to specific manufacturing, assembly and testing applications using conventional programming techniques. The use of a conventional spread sheet program also facilitates integration of information collected by the interactive system with existing information and quality control systems. The method and system also allow easy modification of standard operating procedures to accommodate engineering or design changes. This capability is particularly desirable in the increasingly flexible and agile environment of modem manufacturing.

The combination of a computer directed interactive program with an ergonomically designed workstation further facilitates efficiency. For each step in the process, the workstation monitor displays the proper orientation of a workpiece and provides the user with instructions regarding the necessary tools and procedures to be used for each step of the process. The workpiece together with any necessary tools or measuring devices are located on the workstation in a manner that minimizes unnecessary or potentially dangerous physical motion. The ergonomic design of the workstation and the availability of a specially adapted workpiece support reduces the chances of employee injury and the resulting cost and inefficiency.

The invention also reduces the time and effort necessary to train personnel. For example, the typical automotive quality technician must learn to correctly identify, selected features of each component workpiece, select the appropriate gauge for measuring each selected feature, use the proper measurement technique, correctly read and properly interpret the measurement, and properly record the measurement. In the automotive industry it takes, approximately three weeks to train a quality technician. The interactive system reduces this time from three weeks to a single day. The interactive and network capability of the system also facilitates remote supervision and trouble shooting.

A further advantage of the use of the methods of the present invention is the availability of an electronic record confirming the successful completion of the assembly or testing procedure. One or more testing stations may be connected by a LAN, WAN, Ethernet or Internet. The information can be shared by remote locations. This ability to create store, transmit and access electronic records provides a thorough and easily accessible documentation of the interactive systems success in achieving its stated objectives.

While preferred embodiments of the present invention have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. A system for the manufacture, assembly or testing of components comprising:
a workstation adapted to receive a workpiece wherein the workstation comprises:
(a) a horizontal work surface and at least one generally vertical surface connected to the horizontal surface;
(b) a workpiece support adapted to support and manipulate a workpiece;
(c) one or more attachable tools that may be removably attached to the vertical surface; and
(d) one or more indicators associated with each of the one or more attachable tools to assist a user in determining which attachable tool is to be used;
a microprocessor;
at least one input means through which a user inputs information to the microprocessor;
a spreadsheet control program describing each step of a standard operating procedure;
a system control program that handles operational functions of the workstation while taking sequencing instructions from the spreadsheet control program; and
a monitor linked to the microprocessor for providing instructions and graphical images to assist the user in performing the desired task according to the computer program.

2. The system in claim 1, where the horizontal work surface comprises an acute shape of 120°.

3. The system in claim 1, wherein the attachable tools comprise gages, fixtures and manual devices used in the manufacturing, assembly or testing of the workpiece.

4. The system in claim 1, wherein the plurality of indicators are visual indicators which turn on to indicate which attachable tool needs to be used at a step of the computer program.

5. The system in claim 1, wherein the workpiece support is capable of being moved in various directions as desired by a user.

6. A method for performing standard operating routines using a workstation, a program associated with a microprocessor, a workstation monitor and a plurality of tools to assist a user in performing a desired task, the method comprising:
(a) using the program to provide visual instructions on the workstation mounted monitor to enable a user to perform steps of a standard operating routine;
(b) providing an indication using an indicator located on the workstation, identifying which of the plurality of tools to be used at each of the steps of the standard operating routine;
(c) using an input device to collect and store data in a microprocessor; and
(d) repeating steps (a) through (c) until the standard operating routine has been completed.

7. The method according to claim 6, wherein the instructions provided on the workstation monitor include at least one of: written and graphical instructions to assist a user in understanding how to perform each step of the standard operating routine.

8. The method according to claim 6, wherein the indicator is a LED which is located by the tool to be used for the specific step.

9. The method according to claim 6, further providing a repetitive data entry safeguard to protect against keypunch errors by a user.

10. The method according to claim 6, further comprising detecting whether a user has improperly selected a tool, and indicating to a user that the wrong tool has been selected.

11. The method according to claim 6, wherein a warning is displayed on the display to inform a user that a user has improperly selected a tool.

12. The method according to claim 6, wherein procedure control is derived from a spreadsheet program.

13. The method according to claim 6, further comprising transferring information from the microprocessor to remote devices at remote locations by at least one of:
recording the data on a suitable conventional recording medium, LAN, WAN and the Internet.

14. A method of performing a standard operating procedure using a plurality of tools located on a workstation for a workpiece and a monitor which conveys instructions from a microprocessor to assist a user in performing a desired task, the method comprising:
(a) reading the instructions provided on the monitor describing a step to be performed for a standard operating procedure;
(b) observing various indicators located on the workstation to identify a proper tool from a plurality of tools for a step of the standard operating procedure;
(c) choosing the proper tool to perform a step of the standard operating procedure;
(d) performing a step of the standard operating procedure with the proper tool according to the instructions on the workstation monitor from the microprocessor;
(e) entering data into the microprocessor in response to instructions displayed on the workstation monitor; and
(f) repeating steps (a)-(e) until the standard operating procedure is complete.

15. The method according to claim 14, further comprising detecting that a user has not chosen the proper tool and indicating to the user that an error has occurred.

16. The method according to claim 14, further comprising entering data into a spreadsheet program associated with the microprocessor.

17. An interactive method of training a user to perform a task according to a standard operating procedure comprising the steps of:
(a) providing a workstation equipped with a monitor, a microprocessor with an associate program, at least one input device, and at least one tool for performing steps of a standard operating procedure;
(b) following the program instructions displayed on the monitor to select a tool and perform a step of the steps of the standard operating procedure;
(c) using the input device to record the results of the step;
(d) proceeding to the next step of the steps of the standard operating procedure;
(e) repeating steps (b) through (e) until the standard operating routine has been completed.

18. A system for testing of components comprising:
a workstation,
a computer capable of processing and storing information,
at least one tool removably attached to a designated location on the workstation,
at least one visual indicator located on the workstation and being associated with the designated location of the tool, and
a system control program
a spreadsheet control program associated with the computer and describing at least one step of a standard operating routine using the at least one tool wherein the spreadsheet control program also activates the visual indicator LED associated with the designated location of the at least one tool to be used with the at least one step of the standard operating routine procedure.
